(19) United States
(12) Patent Application Publication
(10) Pub. No.: US 2013/0141736 A1
(43) Pub. Date: Jun. 6, 2013

(54) Control method and apparatus for positioning a moving object

(71) Applicant: Mingwu Bai, Ashburn, VA (US)

(72) Inventor: Mingwu Bai, Ashburn, VA (US)

(21) Appl. No.: 13/308,546

(22) Filed: Dec. 1, 2011

(51) Int. Cl. G01B 11/14

(52) U.S. Cl. 356/623

(57) ABSTRACT

Two or more laser positioning systems are used to position a moving object. The system includes a laser, mirror or photodiodes sensor on three different rotation units. The unit includes two fine rotation and two coarse rotation stages. By rotating fine stages, the laser on the first rotation unit constantly emits laser beam to a mirror on the second rotation unit which is rigidly mounted on the moving object, the mirror constantly reflects laser beam onto a photodiodes sensor on the third rotation unit. The amount of rotations of fine stages and the geometry among laser, mirror and sensor gives precisely the position of the moving object. After fine rotation stages nearly reach their rotation limit, they return to their starting positions by rotating the coarse rotation stages. The fine stages in different laser positioning systems work alternatively to position a moving object in high precision.

### RELATED APPLICATIONS

This application is related to U.S. patent application, with application Ser. No. 13/173,857, entitled “Control method and apparatus for positioning a stage”.

Related patents

| | | |
|---|---|---|
| 2,691,887 | 10/1954 | Rinker |
| 4,012,112 | 3/1977 | Masterson |
| 4,714,339 | 12/1987 | Kam C. Lau |
| 4,724,318 A | 2/1988 | Binnig |
| 5,027,132 | 6/1991 | Manns et al |
| 5,051,594 | 9/1991 | Tsuda et al |
| 5,114,234 | 5/1992 | Otsuka et al |
| 5,323,012 | 1/1994 | Auslander et al |
| 5,552,888 | 3/1996 | Sogard et al |
| 5,548,195 | 8/1996 | Doran |
| 5,663 622 | 9/1997 | Sekiguchi |
| 5,705,741 | 1/1998 | Eaton et al |
| 5,896,032 | 4/1999 | Yagi et al |
| 6,028,305 | 2/2000 | Minne et al |
| 6,049,377 | 4/2000 | Lau et al. |
| 6,267,005 B1 | 7/2001 | Samsavar et al |
| 6,437,864 B1 | 8/2002 | Watanabe et al |
| 6,520,005 B2 | 2/2003 | McWaid et al |
| 6,584,367 B1 | 6/2003 | Makino et al |
| 6,640,459 B1 | 11/2003 | Lucas et al |
| 6,912,054 B2 | 6/2005 | Hill |
| 2007/0229802 | 10/2007 | Lau |
| 7,792,338 B2 | 7/2010 | Bacus et al |

### FIELD OF THE INVENTION

This invention pertains to position a moving object in position measuring, precision installation, positioning stage, guidance system, machine tool alignment, precision machining, and more particularly to control position with very high precision and with large moving range.

### BACKGROUND OF THE INVENTION

GPS receiver measures the distance to four separate satellites by calculating its precise latitude, longitude, and altitude. The satellite is equipped with an extreme accurate atomic clock with time precision to three nanoseconds. GPS receivers can be installed on cars, ships, aircraft, and even can be carried by human hand. GPS can be used all around the earth and has a positioning resolution of around one meter and even less.

Kam C. Lau invented a multi-dimensional measuring system, it comprises a tracking unit that emits laser light and performs tracking using spherical coordinates, and a target in communication with the tracking unit, the target being capable of making pitch, yaw, and roll movements. The absolute distance measurement is accomplished using repetitive time of flight pulses. The system includes a photodetector, a laser amplifier, a laser diode, and a frequency counter. Briefly, a first laser pulse is fired to the target, and upon detecting the return pulse, the detector triggers the laser amplifier and causes the laser diode to fire a second pulse, and the frequency counter detects the pulse. The distance of the target from the tracking unit can be calculated by a D=C/4 (1/f−1/f₀) where C is the speed of light, f₀ is a reference frequency and f is the frequency of the pulses. The system can be used to position stationary object, and it has been used in construction of building, installation of mechanical components, and engineering measurement. Typically such system has a positioning resolution of about one micrometer to tens micrometer.

Frequency-modulated coherent laser radar (FMCLR) instruments precisely measure large-scale geometry without requiring laser tracker spherically mounted retro-reflector or probes. A sensor directs a focused invisible infrared laser beam to a point and coherently processes the reflected light. As the laser light travels to and from the target, it also travels through a reference path of calibrated photodiodes fiber in an environmentally controlled module. The two paths are combined to determine the absolute range to the point. Huge laser-modulation bandwidth of 100 GHz makes it possible for measurement in millisecond. FMCLR technology has been integrated into manufacturing processes of aircraft, large automotive parts and heavy machines. Typically such system has a positioning resolution of about tens micrometer to hundreds micrometer.

Atomic force microscope (AFM) is a very high resolution type of scanning probe microscopy, with demonstrated resolution on the order of fraction of a nanometer. The precursor to the AFM, the scanning tunneling microscope, was developed by Gerd Binnig and Heinrich Rohrerin the early 1980s, a development that earned them the Nobel Prize for Physics in 1986. The AFM consists of a cantilever with a sharp tip at its end to scan a surface. The deflection of cantilever is measured using a laser spot reflected from the surface of the cantilever into a photodiodes sensor. Piezoelectric elements that facilitate tiny but accurate and precise movements on electronic command enable the very precise scanning. The AFM is one of the foremost tools for imaging, measuring, and manipulating matter at the nanoscale, but the working area is limited in less than about tens micron square.

Capacitive sensor measures the changing electric field in a gap between two parallel surfaces. Capacitance refers to the capacity of two plates to hold this charge. The typical capacitance sensor can detect variance of distance in a fraction of nanometer. Using capacitance sensor technology, Asylum Research Inc. has developed a new generation AFM, and Hysitron Inc. has developed cutting-edge nano-indentation apparatus for evaluating mechanical properties of materials at nanoscale. Similar to piezoelectric element in AFM, capacitive sensor working area is also very small, usually less than 1 millimeter.

Using very small, stable and accurately defined wavelength of light as a unit of measurement, light interference principle has been widely used in industrial automation for positioning and controlling. The instrument is basically composed of a stationary laser, a stationary interferometer, and a moving reflector. During operation, an infra-red LED emits light onto the angled scale facets where it is directed back into the readhead through a transparent phase grating. This produces sinusoidal interference fringes at the detection plane within the readhead. The photodiodes scheme averages the contributions from many facets and effectively filters out signals not matching the scale period. This ensures signal stability even when the scale is contaminated or slightly damaged. The range of measurement can be as large as meter scale with resolution tens micron, fraction of a micron, or even to tens nanometer, depending heavily on the performance of readhead, the fineness of scale, and combination of other technology such as a closed loop laser feedback solution with laser encoder techniques. No matter how good the laser unit is (i.e. how accurate and how stable it is) the measuring wavelength can be altered as the light passes through air because the air temperature, air pressure and relative humidity vary from the “standard” values. Even some wavelength compensation is used, some small errors still exist. Also, thermal growth of the laser head changes the measuring path length, so additional warm-up time is needed before accurate measurements can be taken. Furthermore, frequency of returned beam from moving reflector is doppler shifted, a complex electronics and calculation need be included for the instrument in the case of positioning a high speed moving object. The above mentioned techniques have been used by some well-known photodiodes linear encoder system manufactures such as Renishaw, Heidenhain, RSF, Zeiss, DRC, and AMO etc.

To meet increasing demands for the extremely accurate positioning in semiconductor industry, in engineering automation industry, and in precision machining industry, in stead of using frequency related techniques, this invention use the laser reflection and position calculation techniques in order to significantly increase the resolution of measurement, present invention can positioning a moving object not only in two dimension but also in three dimension with resolution of sub nanometer in very large range.

### SUMMARY OF THE INVENTION

According to present invention, the position of an object that moves in x-axis direction, y-axis direction, and z-axis direction relative to a stationary base can be measured by the geometrical relationships among the positions laser, mirror, and photodiodes sensor of two to four laser positioning systems, each laser positioning system consists of a laser, a reflective mirror, and a photodiodes sensor. The laser, mirror, and photodiodes sensor are separately mounted on three rotation units. Each rotation unit comprises of two fine rotation stages and two coarse rotation stages. Each stage can independently rotate around x-axis or z-axis. For each laser positioning system, the first rotation unit integrally mounted on a stationary base, the second rotation unit rigidly attached on a moving object, and the third rotation unit integrally mounted on a stationary base. After installation and pre-adjusting, in each laser positioning system, laser is emitted to a mirror and reflected onto a photodiodes sensor. When the object is moving, fine stages are set to rotate so that a laser on the first rotation unit constantly emits laser beam to a mirror on a second rotation unit, and the mirror constantly reflects laser beam onto a photodiodes sensor on the third rotation unit. The amount of rotations of fine stages and geometry of position of laser and mirror gives precisely the position of moving object. After fine rotation stages nearly reach their rotation limit, the fine stages return to its starting position gradually, and at the same time the coarse rotation stage moves to keep the laser constantly reflected onto the photodiodes sensor. The fine stages in different laser positioning units work alternatively to position a moving object.

### BRIEF DESCRIPTION OF THE DRAWINGS

FIG. 1 is a schematic perspective view of a laser and a projection wall in XYZ coordinate. The laser points to A, B, C, D or E if the laser rotates around z-axis, and the laser points to G, F, A, H or J if the laser rotates around x-axis.

FIG. 2 is perspective view of schematic diagram of coarse rotation stage; a precision motor (stepper motor, servo motor, or supersonic motor etc, not shown) is used to drive the rotation stage which has large range in rotation.

FIG. 3 is perspective view of schematic diagram of fine rotation stage, symmetrical spring hinges are distributed around the center, piezoelectric stacks (not shown) is used to drive the spring hinges with very high resolution and without friction.

FIG. 4 is top view of schematic diagram of fine rotation stage. The symmetrical spring hinges are distributed around the center, piezoelectric stacks (not shown) is used to drive the spring hinges with very high resolution and without friction.

FIG. 5 is a schematic view of photodiodes sensor which comprises of four sections with very narrow gap between adjacent sections.

FIG. 6 is a schematic view of reflected laser (from a mirror, not shown) onto photodiodes sensor. The split-diode photodetector generates four currents from A, B, C, and D split diodes respectively.

FIG. 7 is a schematic perspective view of a rotation unit comprises of a fine rotation stage and a coarse rotation stage.

FIG. 8 is an exploded perspective view of a rotation unit comprises of a fine rotation stage and a coarse rotation stage.

FIG. 9 is a schematic perspective view of a rotation unit comprises of two fine rotation stages and two coarse rotation stages.

FIG. 10 is an exploded perspective view of a rotation unit composed of two fine rotation stages and two coarse rotation stages.

FIG. 11 is a schematic perspective view of two laser positioning systems, each laser positioning system comprises of three rotation units which rigidly hold laser, mirror, or photodiodes sensor respectively. The rotation unit that holding a mirror is rigidly mounted on a moving objects.

FIG. 12 is a schematic top view of two laser positioning systems, each laser positioning system comprises of three rotation units which rigidly hold laser, mirror, or photodiodes sensor respectively. The rotation unit that holding a mirror is rigidly mounted on a moving objects.

FIG. 13 is a schematic perspective view of one laser positioning system comprising three rotation units which rigidly hold laser, mirror, or photodiodes sensor respectively. The rotation unit that holding a mirror is rigidly mounted on a moving objects.

FIG. 14 is a schematic perspective view of three laser positioning systems, each laser positioning system comprises of three rotation units which rigidly hold laser, mirror, or photodiodes sensor respectively. The rotation unit that holding a mirror is rigidly mounted on a moving objects.

FIG. 15 is a schematic perspective view of four laser positioning systems, each laser positioning system comprises of three rotation units which rigidly hold laser, mirror, or photodiodes sensor respectively. The rotation unit that holding a mirror is rigidly mounted on a moving objects.

### DESCRIPTION OF PREFERRED EMBODIMENTS

Although the present invention can be made in many different forms, the presently preferred embodiments are described in this disclosure and shown in the attached drawings. This disclosure exemplifies the principles of the present invention and does not limit the broad aspects of the invention only to the illustrated embodiments.

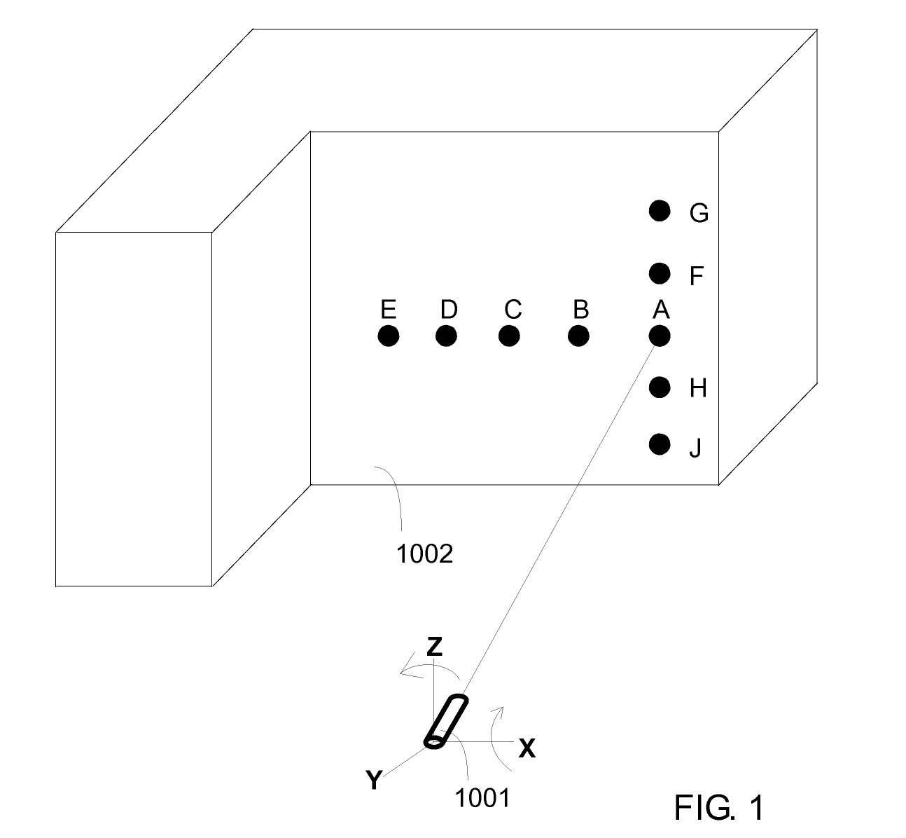

FIG. 1 schematically illustrates a laser 1001 which can rotate around x-axis and z-axis respectively, and an object 1002 which can move in three dimensions. When the laser 1001 rotates around z-axis, it will produce bright point on position “A”, “B”, “C”, “D”, and “E” on the object 1002 respectively. Similarly, when the laser 1001 rotates around x-axis, it will produce bright point on the position “G”, “F”, “A”, “H”, and “J” on the object 1002 respectively. Therefore, the combination rotations of laser around both x-axis and z-axis will produce light point in any position on the object 1002.

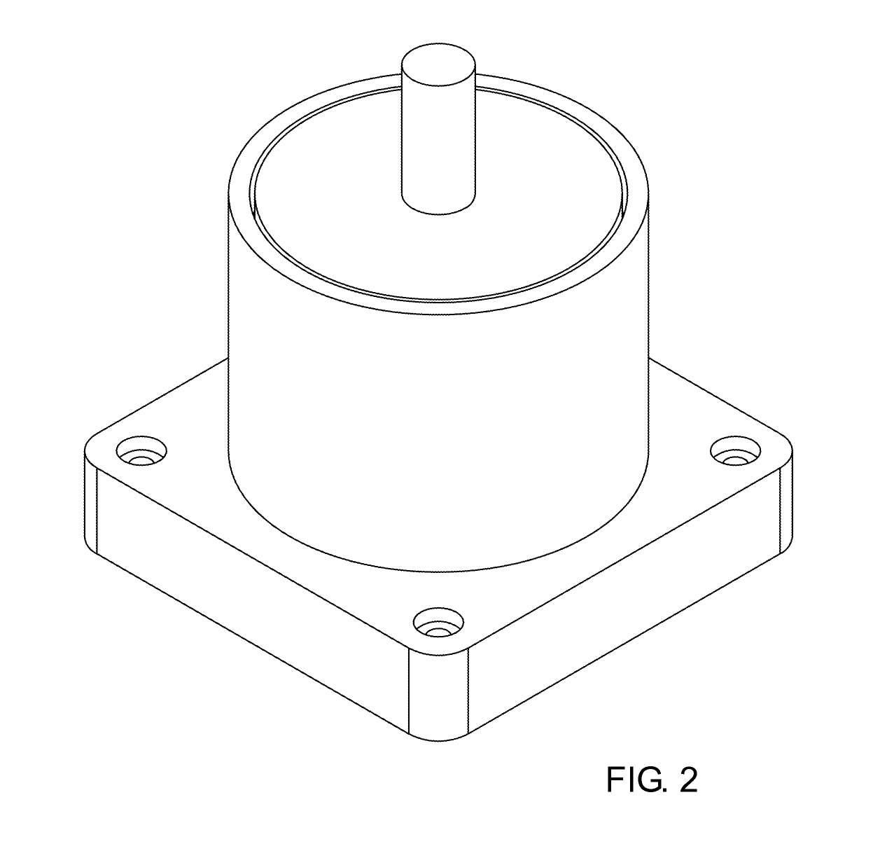

FIG. 2 schematically illustrates a coarse rotation stage with a shaft which can be rigidly mounted into another component. A coarse rotation stage is a conventional linear rotator with large rotation range (from sub rad to several rad, or from several degrees to tens or hundreds degree) but low resolution (from sub mrad to hundred mrad). Usually a motor such as precision stepper motor or servo motor is used to drive the conventional linear rotator with or without an optical linear encoder system.

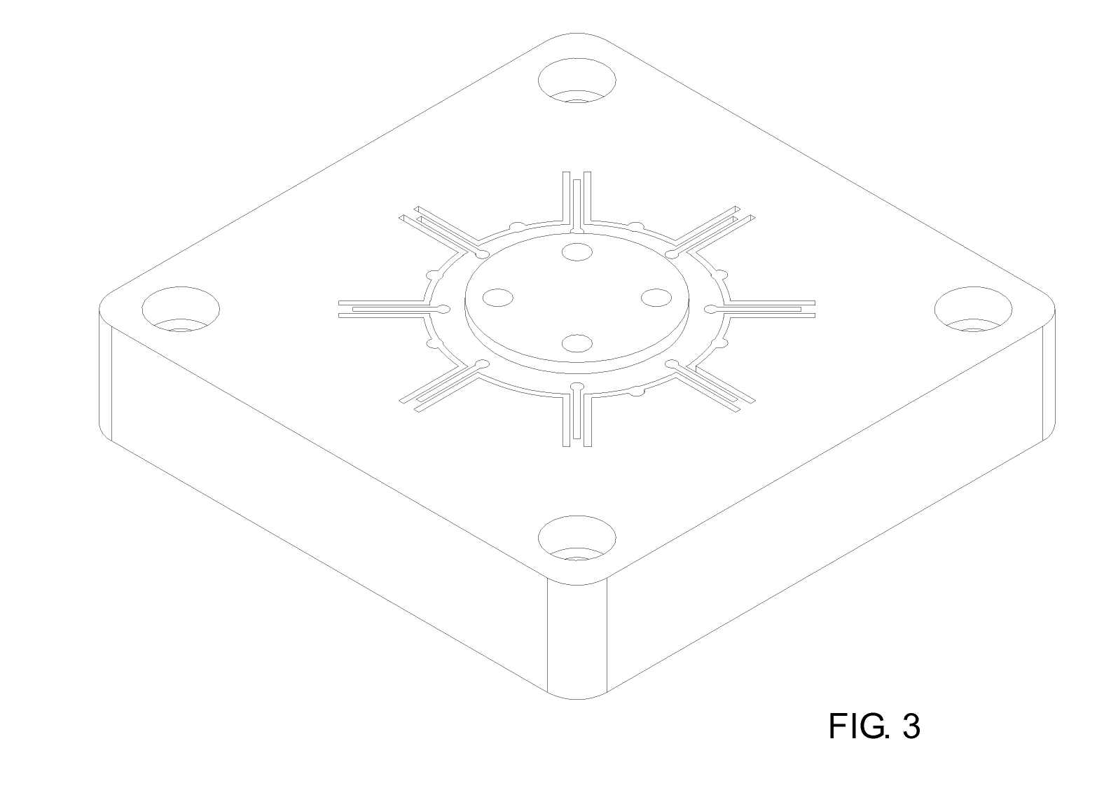

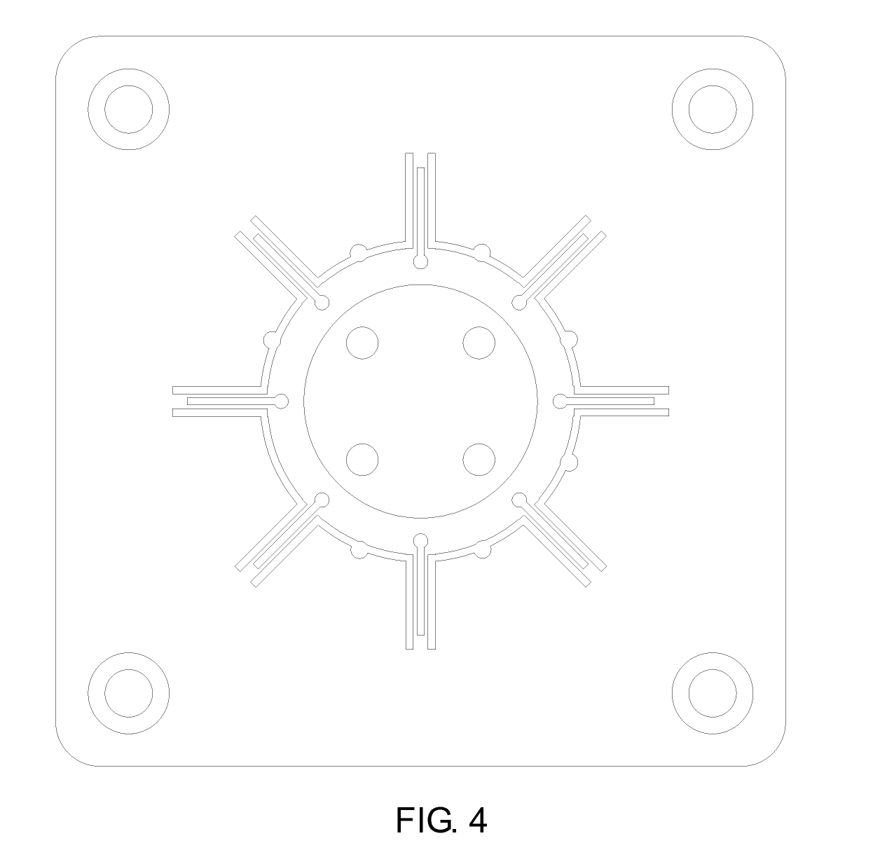

For the purpose of schematic illustration in FIG. 3, a fine rotation stage is a linear rotator with unique flexure hinges. With piezoelectric actuation, it provides high degree of repeatability and rotation resolution due to the frictionless hinge. The range of rotation can be tens or hundreds of mrad, with resolution to several nrad (nano-rad). FIG. 4 shows a top view of the fine rotation stage.

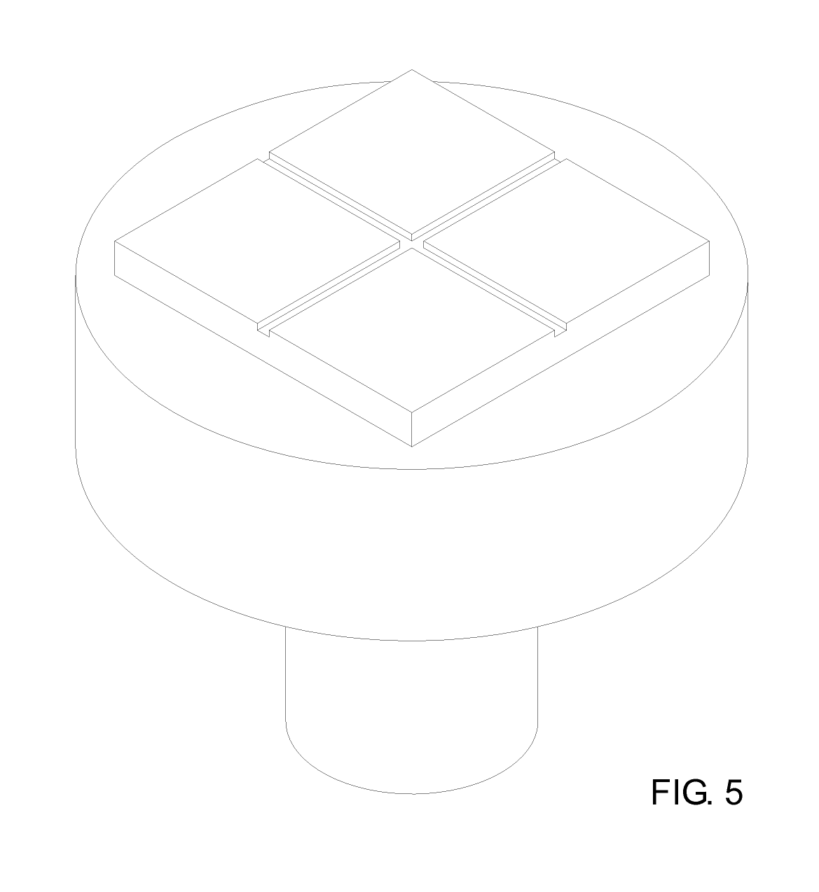

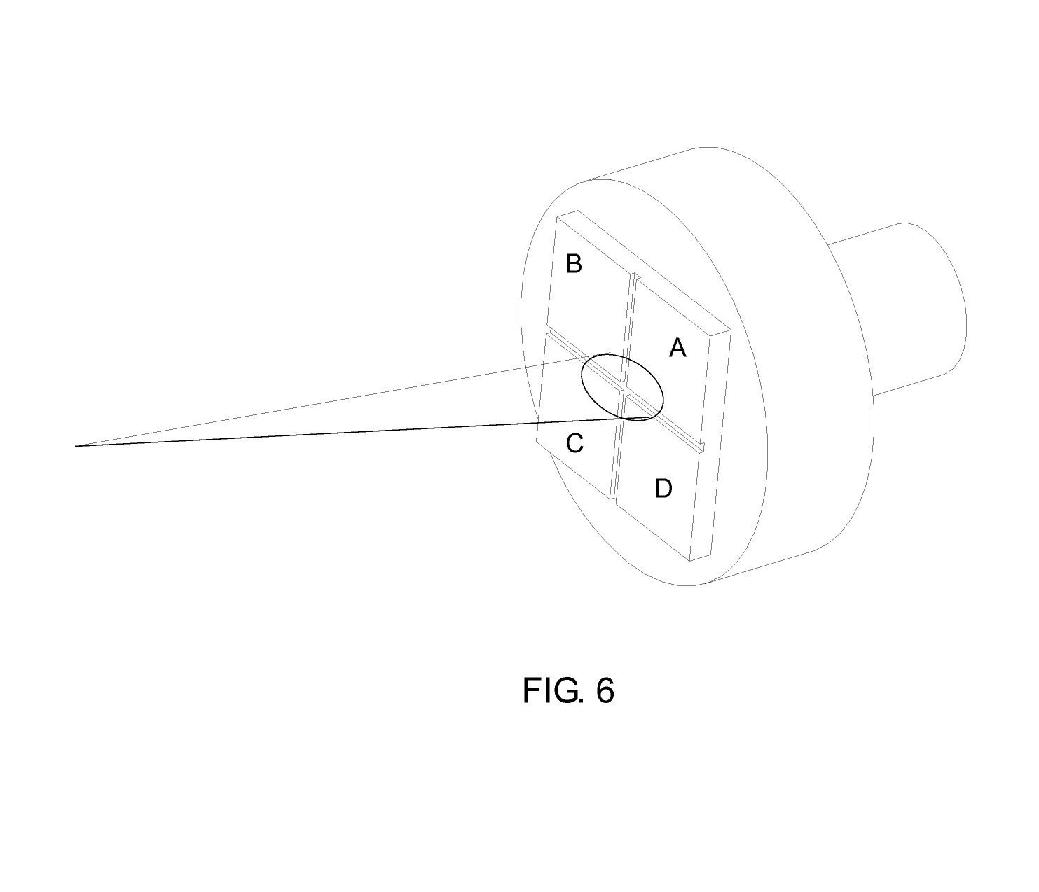

FIG. 5 is a schematic view of a photodiodes sensor. The sensor is a quad photodiode array with current-to-voltage amplifiers that provide bottom minus top and left minus right difference signals. FIG. 6 is a schematic view of a photodiodes sensor when a laser beam emitted onto the sensor, each segment of quad photodiode is marked as A, B, C, and D respectively, the gap between the segments is extremely small. The difference signals are voltage analogs of the light intensity difference sensed by the pairs of photodiode elements in the array. With the similar principle that applied in AFM, a mirror is used to reflect a laser beam onto a photodiodes sensor, the photodiodes sensor can tell the position of mirror at a resolution of nanometer and sub-nanometer, and it also can indicate the moving direction of laser beam by the difference signals.

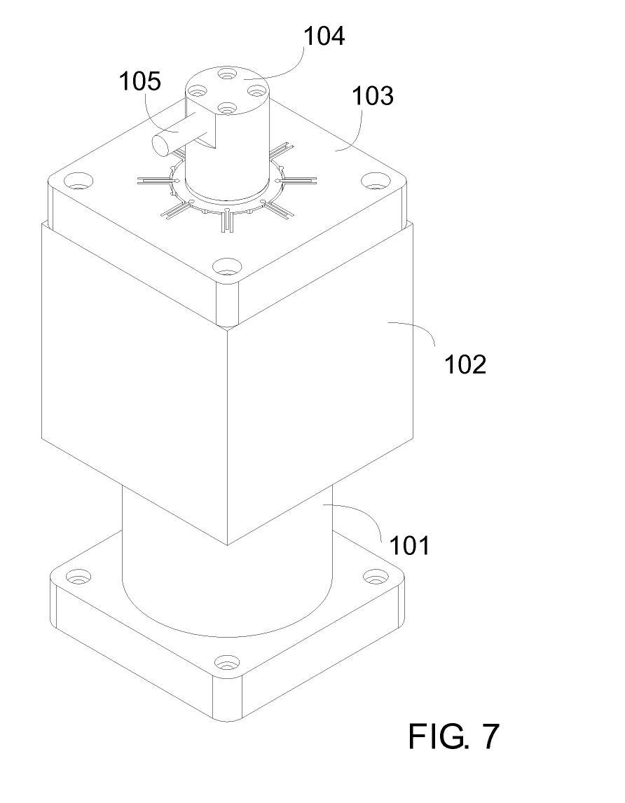

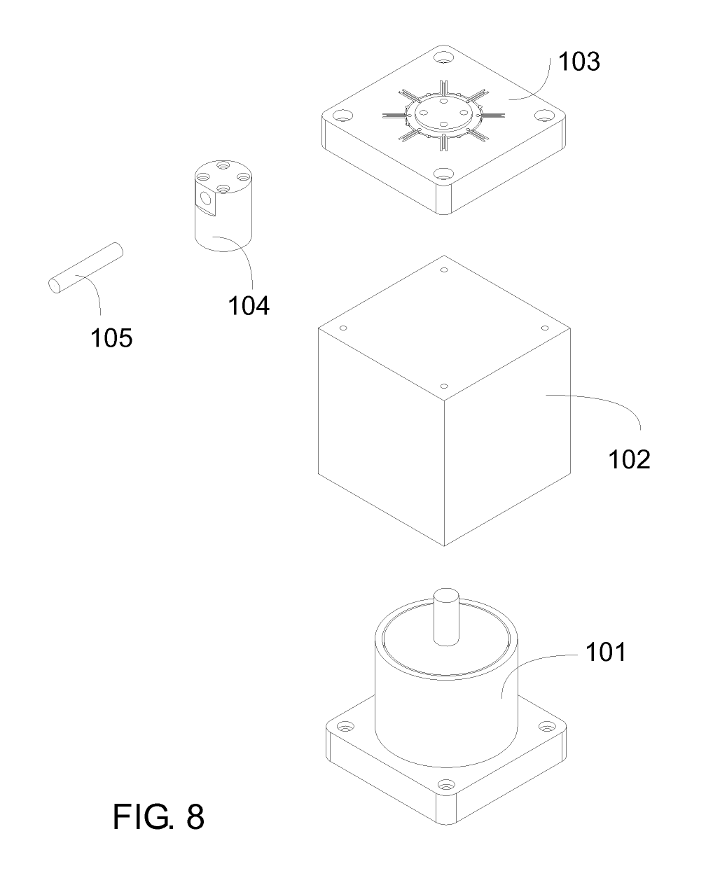

FIG. 7 is a schematic view of a rotation unit which comprised of a fine rotation stage and a coarse rotation stage. As shown in an exploded perspective view of the rotation unit in FIG. 8, a fine rotation stage 103 is rigidly mounted onto a shaft of a coarse stage 101 by a stage holder 102, a holder 104 is rigidly mounted on the fine rotation stage 103. A laser 105 is rigidly mounted on the holder 104. As seen in FIG. 7 and FIG. 8, when the coarse rotation stage 101 or/and the fine rotation stage 103 rotates, the laser 105 will rotate.

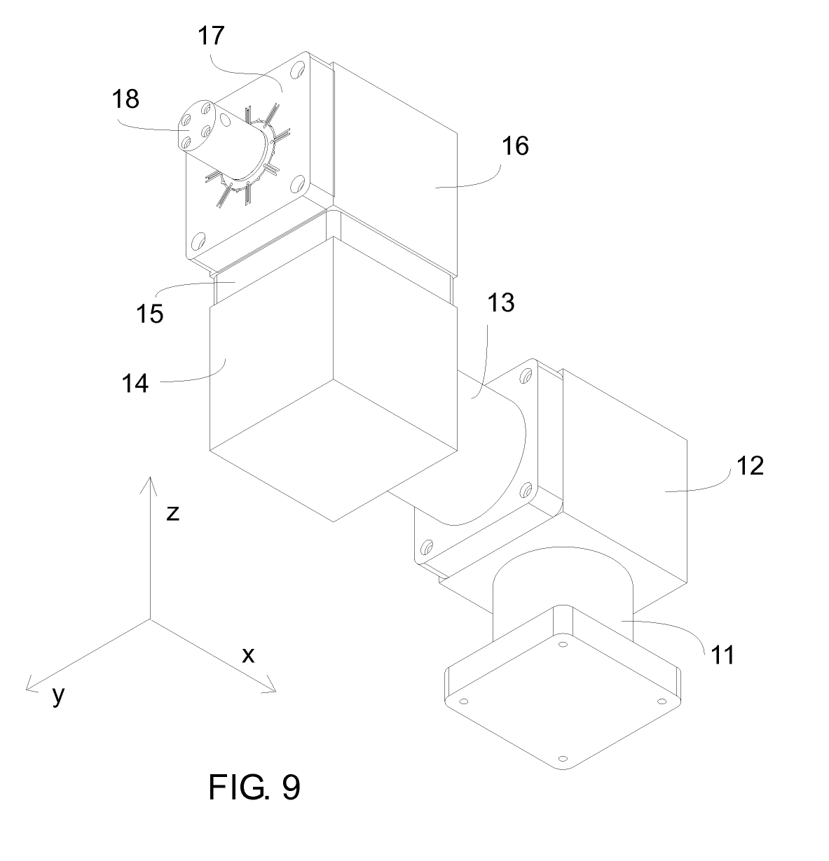

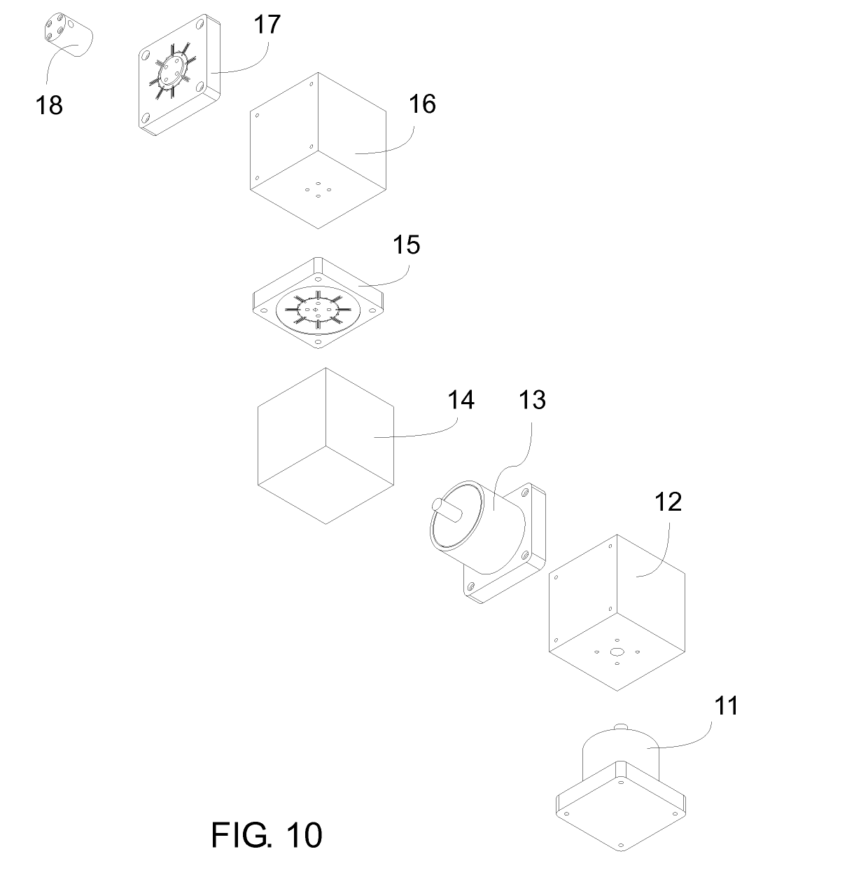

Similarly, FIG. 9 is a schematic view of a rotation unit which comprised of two fine rotation stages and two coarse rotation stages. As shown in an exploded perspective view of the rotation unit in FIG. 10, a fine rotation stage 17 is rigidly mounted on another fine rotation stage 15 by a stage holder 16, a coarse rotation stage 13 is rigidly mounted on a shaft of another coarse rotation stage 11 by a stage holder 12, and the fine rotation stage 15 is rigidly mounted on the shaft of the coarse rotation stage 13 by a stage holder 14. When a laser, a mirror, or a photodiodes sensor (all not shown) is rigidly attached on the holder 18, the rotation of holder 18 is a result of combination of rotations of two fine rotation stages 17 (around x-axis) and 15 (around z-axis), and of two coarse stages 13 (around x-axis), and 11 (around z-axis). Also see FIG. 1, the rotation unit in FIG. 9 can rotate a laser, a mirror, or a photodiodes sensor (all not shown) which is rigidly mounted on the holder 18 around x-axis and z-axis.

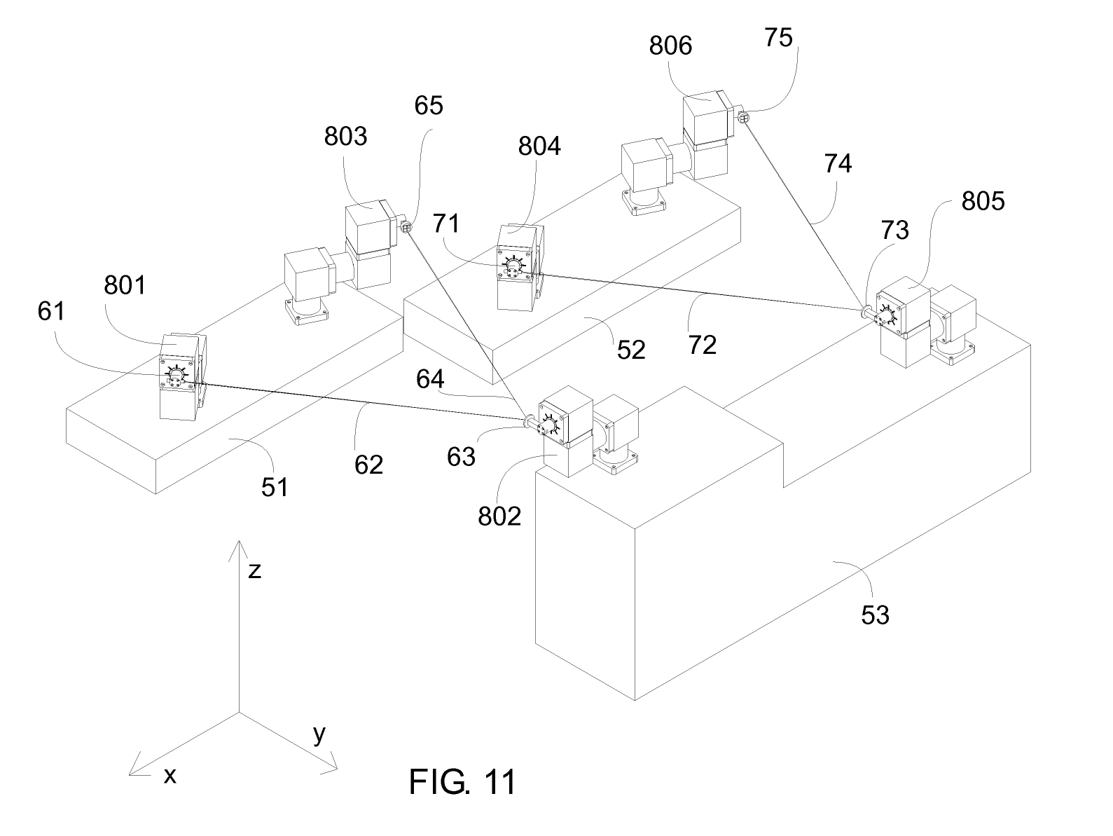

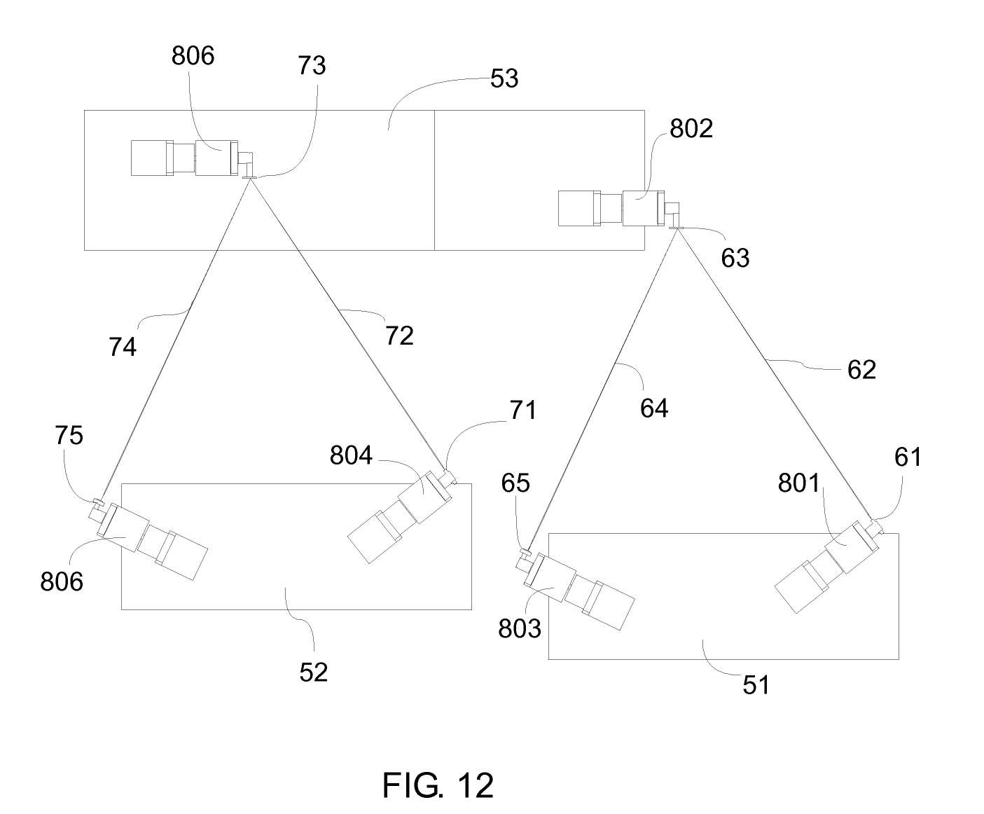

FIG. 11 is a schematic view of two laser positioning systems, stationary base 51, stationary base 52, and moving object 53. In the first laser positioning system, a laser 61 is rigidly mounted on the first rotation unit 801, a mirror 63 is rigidly mounted on the second rotation unit 802, and a photodiodes sensor 65 is rigidly mounted on the third rotation unit 803. The laser beam 62 emitted from laser 61 is reflected by the mirror 63, the reflected beam 64 is pointed on the photodiodes sensor 65. Similarly, for the second laser position system, a beam 72 from laser 71 is reflected by a mirror 73, the reflected beam 74 is pointed on the photodiodes sensor 75. The laser 71, mirror 73, and photodiodes sensor 75 are rigidly mounted on three rotation units 804, 805, and 806 respectively. FIG. 12 is a top view of two laser position systems, stationary base 51, stationary base 52, and moving object 53 as shown also in FIG. 11.

Before operation, as shown in FIG. 11 and FIG. 12, all rotation stages in two laser positioning systems are rotated and adjusted so that the laser beam can be reflected onto the center of photodiodes sensor by a mirror, and further more, all fine rotation stages in the first laser positioning system (rotation units 801, 802, 803) are adjusted to about the starting position of the full scale by adjusting coarse rotation stages, meanwhile, all fine rotation stages in the second laser positioning system (rotation units 804, 805, 806) are adjusted to the middle position of the full scale by adjusting coarse rotation stages. For example, if the fine rotation stage has a range of 100 mrad, all fine rotation stages in the first laser positioning system are adjusted to about 0 mrad, meanwhile, all fine rotation stages in the second laser positioning system are adjusted to about 50 mrad. By calibration and pre-measurement, the relative distance between two rotation units 801 and 803 in the first laser position system is known, and the relative distance between two rotation units 804 and 806 in the second laser position system is also known.

During operation, when moving object 53 is moving in XZ plane (FIG. 11), all fine rotation stages are rotated respectively so that the lasers are always reflected to the about center of the photodiodes sensor. Therefore, the moving distance of moving object 53 can be calculated dynamically by the rotations of fine rotation stages using triangle geometry relationships among three rotation units (801, 802, 803) in the first laser positioning system. Because only fine rotation stages are rotating during this stage, so the high resolution of fine rotation stages guarantees the high precision of calculated moving distance of moving object 53. When one or more fine rotation stages in the first laser position system rotates to near the middle of full range, one or more fine rotation stages in the second laser position system rotates to near the end of full range, at this moment, all fine rotation stages in the first laser positioning system keep moving and meanwhile the fine rotation stages in the second laser positioning system rotate back to the starting position of full range by rotating coarse stages to keep that the laser is always reflected to the center of photodiodes sensor by the mirror. After coarse rotation stages are stationary temporally when fine rotation stages finishing moving back to starting position of a full range, the positions of fine rotation stages can be re-calibrated using the positions of fine rotation stages in the first laser positioning system, therefore the moving errors of coarse rotation stages are eliminated.

Similarly, when the fine rotation stages in the first laser positioning system rotates to near their full range, the fine rotation stages in the second laser positioning system is rotating near their middle range, so the fine rotation stages in the first laser positioning can rotates back to their starting position of a full range by rotating coarse rotation stage. During this time, the moving distance of moving object 53 can be calculated dynamically using triangle geometry relationships by the rotations of fine rotation stages among three rotation units (804, 805, 806) in the second laser positioning system.

By duplicating above procedures, the position of moving object 53 can be continuously calculated by the rotations of fine rotation stages alternatively from either the first laser positioning system or the second laser positioning system.

It should be mentioned that, when coarse rotation stage rotates, there are large rotation errors in comparison with the resolution of fine rotation stage. Because coarse rotation stages in two laser positioning systems are alternatively worked, and only the rotation of fine rotation stages are used for calculation, so it produce the calculation results of position of moving object 53 with high precision. Further more, after coarse rotation stages finishing rotation for adjusting fine rotation stages in one laser positioning system, the position of fine rotation stages can be re-calibrated precisely based on the position of fine rotation stages in another laser positioning system in which all coarse rotation stage are stationary at this moment.

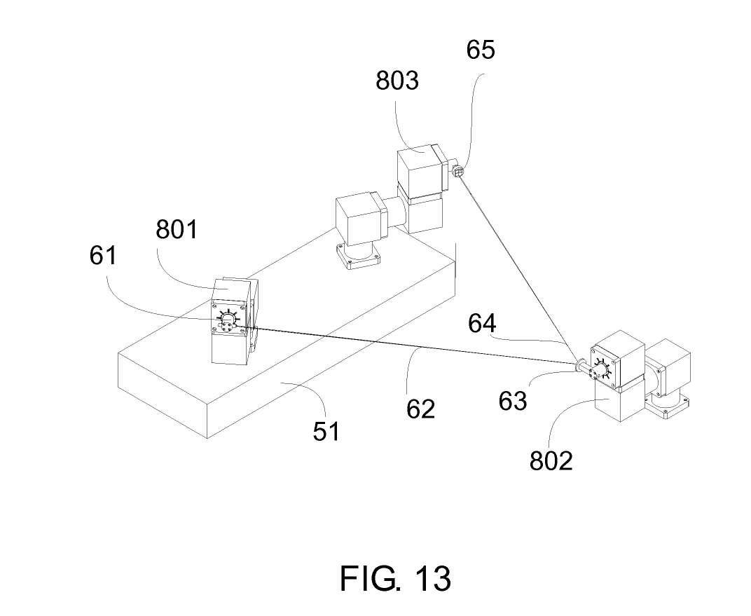

As an alternative embodiment, in some special application such as surface imaging where the moving object can be temporarily stopped, only one laser positioning system can get the job done. FIG. 13 schematically shows that one laser positioning system is used to position the moving object. In this case, when the fine rotation stages arrive their full range, the moving object can be stopped temporarily for rotates back the fine rotation stages to their starting position of full range, by rotating coarse stages simultaneously. After finishing rotating coarse stages, the position of fine rotation stages can be re-calibrated based on the position of “stationary” moving object which is related to the position of fine rotation stage before rotating the coarse rotation stage.

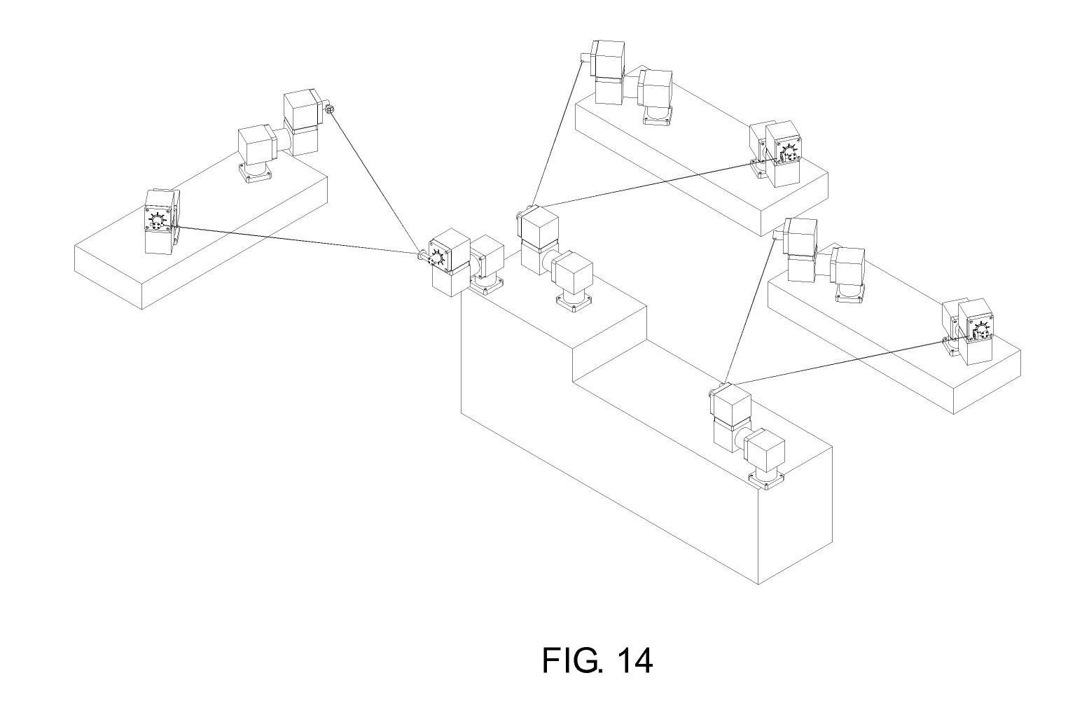

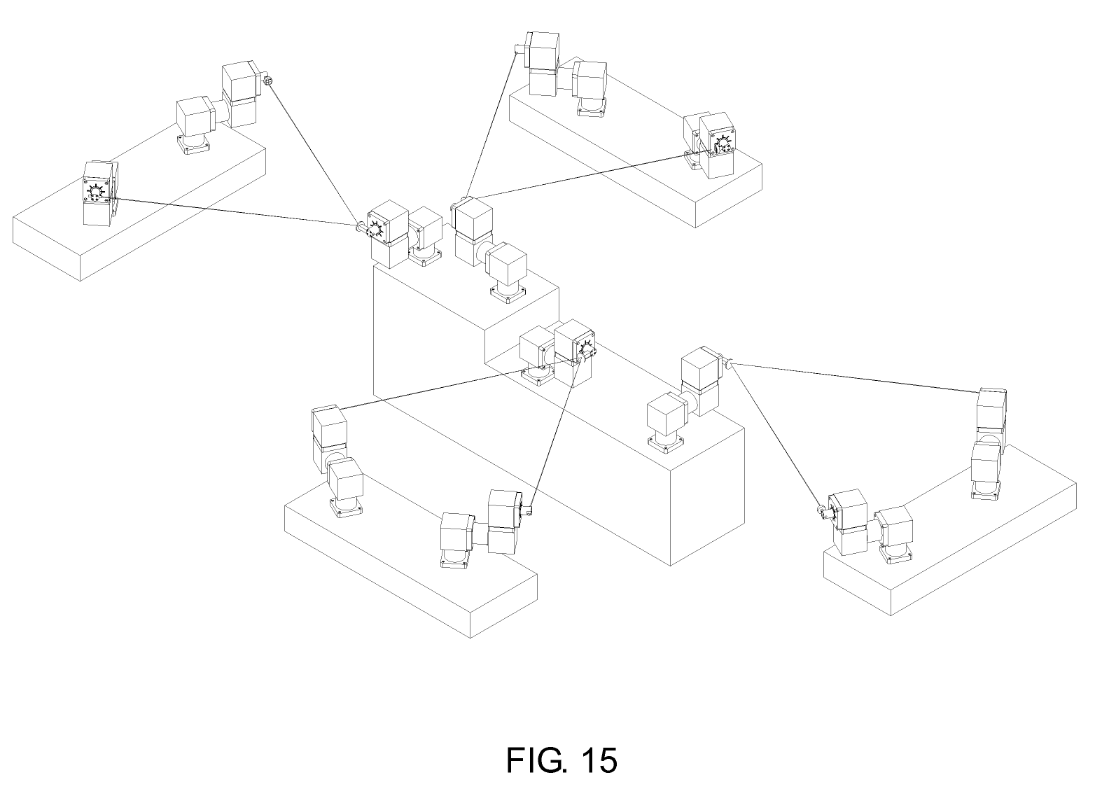

When moving object moves in three dimensions, or it is needed to positioning with better precision, three, four or even more laser positioning system can be adopted for such purpose. FIG. 14 schematically shows three laser positioning systems, and FIG. 15 schematically shows four laser positioning systems, each laser positioning system comprises of three rotation units which rigidly hold laser, mirror, or photodiodes sensor respectively. The rotation unit that holding a mirror is rigidly mounted on a moving objects.

According to another aspect of the present invention, positioning errors can be calculated from photodiodes sensors. As shown in FIG. 6, for the purpose of illustration, the reflected laser beam from a mirror is directed to a photodiodes sensor. The photodiodes sensor is segmented into four separate active areas. There are well defined gap between the adjacent elements (A, B, C, and D in FIG. 6) resulting in high response uniformity between the elements. For the photodiodes sensor, the differential signal from the top and bottom photodiodes ((A+B)−(C+D), FIG. 6) provides the signal which is a sensitive measure of the platform vertical deflection, and the signal from the left and right ((A+C)−(B+D)) photodiodes provides the signal which is a sensitive measure of the platform horizontal deflection.

With above disclosed method and apparatus, a moving object can be positioned at very high precision with large range, so it can be applied in machine tool alignment, position measuring, beam centering, targeting, and guidance systems.

According to the provisions of the patent statues, we have explained the principle, preferred construction of the invention and have illustrated and described what we now consider to represent its best embodiments. However, it should be understood that within the scope of the claims and the foregoing description, the invention may be practiced otherwise than specifically illustrated and described.

What is claimed is:

1. Control method for positioning a moving object, comprising steps of:
In each laser positioning system of two or more laser positioning systems,
emitting a laser beam from a laser onto a mirror by rotation of the first two fine rotation stages which hold said laser;
reflecting said laser beam from said mirror onto a stationary photodiodes sensor by rotation of the second two fine rotation stages which hold said mirror;
detecting reflected laser beam from said mirror onto said photodiodes sensor by rotating the third two fine rotation stages which holds said photodiodes sensor;
constructing a tri-angle geometry by the positions of said laser, said mirror, and said photodiodes sensor for calculating position of said mirror which is rigidly attached on said moving object;
before operation, set all said fine rotation stages in said first laser positioning system to the starting position of full range, and set all said fine rotation stages in said second laser positioning system to the middle position of full range;
during operation, rotating all said fine rotation stages so that said laser can be continuously reflected by said mirror onto said photodiodes sensor;
during operation, for the photodiodes sensor which has well defined gap between the adjacent elements, the differential signal from the top and bottom photodiodes provides a signal which is a sensitive measure of the vertical deflection of said laser beam, and the signal from the left and right photodiodes provides the signal which is a sensitive measure of the horizontal deflection of said laser beam, said deflections help to guide the rotation of said fine rotation stages and to calculate the position of said moving object in very high precision;
returning said two fine rotation stages in said second laser positioning system to their starting positions of full range if they reach their range limits, by rotating two coarse rotation stages which hold said two fine rotation stages, meanwhile constantly keeping laser beam projected on said photodiodes sensor;
re-calibration positions of said fine rotation stages after said coarse stages finishing rotation and are stationary temporarily;
returning said two fine rotation stages in said first laser positioning system to their starting positions of full range if they reach their range limits by similar procedures used in said second laser positioning system; and
repeating above operations by running both said laser positioning systems simultaneously, the position of said moving object is the positions of said mirror in any of said laser positioning systems in which said fine rotation stages are rotating and said coarse rotation stages are stationary temporarily.

2. Apparatus for positioning a moving object, comprising:
a moving object which is moving in XZ plane, two or more laser positioning systems,
each said laser positioning system includes a laser rigidly attached on the first rotation unit, a mirror rigidly attached on the second rotation unit, and a photodiodes sensor which is split-diode photodetector and is rigidly attached on the third rotation unit,
said rotation unit includes two fine rotation stages which can rotate around x-axis and z-axis independently, and two coarse rotation stages which can rotate around x-axis and z-axis independently,
said fine rotation stage has very high rotation resolution but short rotation range, and said coarse rotation stage has a large rotation range but low resolution,
for each laser positioning system, said first rotation unit integrally mounted on a stationary base, said second rotation unit rigidly attached on a moving object, and said third rotation unit integrally mounted on a stationary base.
